(19) United States
(12) Patent Application Publication
(10) Pub. No.: US 2006/0253701 A1
(43) Pub. Date: Nov. 9, 2006

(54) Method for providing end-to-end security service in communication network using network address translation-protocol translation

(76) Inventors: Sun-Gi Kim, Seoul (KR); Young-Han Kim, Seoul (KR); Sou-Hwan Jung, Seoul (KR); In-Seok Choi, Seoul (KR); Byung-Chang Kang, Yongin-si (KR); Yong-Seok Park, Seongnam-si (KR); Du-Young Oh, Hwaseong-si (KR)

Correspondence Address: Robert E. Bushnell;Suite 300, 1522 K Street, N.W., Washington, DC, 20005-1202, US

(21) Appl. No.: 11/119,727

(22) Filed: May 3, 2005

(51) Int. Cl. H04L 9/00

(52) U.S. Cl. 713/153

(57) ABSTRACT

A method for providing end-to-end security service in a communication network having an NAT-PT function comprises: performing security negotiation between a first node included in a first communication network having the network address translation-protocol translation function and a second node included in a second communication network operating with a protocol different from the first communication network; storing protocol translation information generated when the security negotiation is performed in the first node; and performing security transmission between the first and second nodes using the stored protocol translation information. The method transmits the address translation information to the ends in advance, thereby being capable of applying the security service using the address information on transmitting the data between hosts in the communication network using the address translation method.

### BACKGROUND OF THE INVENTION

1. Technical Field

The present invention relates to an IPv6 (Internet Protocol version 6) network and, more particularly, to a method for providing end-to-end security service in an IPv6 network having an Network Address Translation-Protocol Translation (NAT-PT) function.

2. Description of the Related Art

A network protocol that is widely used on the basis of an Internet at the present time is the Internet Protocol (IP). The IP plays a decisive role in interconnecting numerous networks and users through a huge single network, called the Internet, for a short time.

The IP has been developed through design variation many times, and the current version of IP is IPv4 (Internet Protocol version 4), which is widely used throughout the Internet. The IPv4 has the advantage of being a relatively simple and flexible in design, but it has disadvantages such as shortage of usable IP addresses, inefficiency of IP packet routing processing, and complexity of various setting processes required for operation of IP nodes.

In order to overcome these disadvantages, IPv6 (also known as IPng or IP next generation) has been proposed, and has now become the standard.

Accordingly, the number of network elements using the IPv6 has recently increased, so that the IPv6 network is widely diffused. However, most network equipment is still being used in the existing IPv4 network. For this reason, it is required to interwork between the IPv6 network and the IPv4 network. To this end, mutual translation of IP addresses between the IPv6 network and the IPv4 network is required.

In other words, in order for nodes connected to the IPv6 network to interwork and communicate with nodes connected to the IPv4 network, an address translator providing mutual translation between IPv6 address and IPv4 address is required.

Up to now, many translation technologies have been standardized in the Internet Engineering Task Force (IETF). Among them, two technologies—network address translation-protocol translation (hereinafter, referred to as “NAT-PT”) and Dual Stack Translation Mechanism (DSTM)—are on the rise. The present invention is directed to the NAT-PT.

The NAT-PT is a standard defined as RFC 2766 in the IETF (which is the international organization for standardization of Internet), and it specifies IPv6-IPv4 translation. This NAT-PT technology enables communication between hosts or applications connected to the IPv6 network and hosts or applications connected to the IPv4 network. In this case, the hosts for the IPv6 network and the hosts of the IPv4 network have only an IPv6 stack and an IPv4 stack, respectively, while a device for performing the NAT-PT (the so-called “NAT-PT server”, hereinafter referred to as NAT-PT) has an IPv4/IPv6 dual stack. Further, the NAT-PT server is located on the boundary between the IPv6 network and the IPv4 network. Preferably, the NAT-PT server is located at the position where a boundary router is located. And the NAT-PT server has an IPv4 address pool wherein IPv4 addresses, to be dynamically allocated, are collected when hosts connected to the IPv6 network intend to communicate with hosts connected to the IPv4 network.

Generally, the NAT-PT performs two functions. The first function is network address translation, by means of which the IPv6 address of the IPv6 node is translated into the IPv4 address whenever a session is initialized on the basis of the IPv4 address pool, that is to say, the IPv4 address is dynamically allocated to the IPv6 node. The second function is protocol translation, by means of which address translation is performed based on an RFC 2765 standard document (SIIT: Stateless IP/ICMP translation algorithm) that defines translation function at the hosts.

In particular, the NAT-PT makes use of an IP header translation method in order to support communication between the IPv6 node operating only with IPv6 and the IPv4 node.

Meanwhile, as an example of a security function for implementing safe communication in the Internet, there is a communication protocol, known as ‘IPsec (Internet Protocol Security),’ for providing end-to-end security services.

IPsec is a communication protocol for establishing an available virtual dedicated line on the Internet to prevent illegal actions, such as eavesdropping data. This communication protocol can be implemented at a user side station. IPsec allows only specific clients and servers to transmit and receive data through the Internet. Further, IPsec does not define an encrypting or authenticating mechanism, but it provides a framework for notifying the mechanism. This framework is called Security Association (SA). IPsec provides two kinds of security services: an authentication header (AH), which essentially allows authentication of the transmitter of data; and an encapsulating security payload (ESP), which supports both authentication of the transmitter and encryption of data. The specific information associated with each of these services is inserted into the packet in a header that follows the IP packet header.

Particularly, IPsec generates mutual authentication information using header information (e.g., address information) of each of the nodes (e.g., the IPv6 node and the IPv4 node) to transmit/receive the data. Thus, when contents of the packet (e.g., address information) are varied in the course of transmitting the packet like the transmission of data using NAT-PT, it is impossible to provide the security service using IPsec.

Consequently, when data are transmitted between hosts in a communication network using the conventional address translation method, there is a disadvantage in that the security service using IPsec cannot be applied. For example, when data are transmitted between an IPv6 host and an IPv4 host in an IPv6 network having the NAT-PT function, the security service using IPsec has not been applied.

### SUMMARY OF THE INVENTION

It is, therefore, an objective of the present invention to provide a method capable of providing security service in a communication network using an address translation method using IPsec.

It is another objective of the present invention to provide a method for providing end-to-end security service in an IPv6 network having an NAT-PT function using IPsec.

It is yet another objective of the present invention to provide a method for transmitting data between ends in an IPv6 network having an NAT-PT function in the maintenance of security.

According to an aspect of the present invention, there is provided a method for providing end-to-end security service in a communication network having a network address translation-protocol translation function. The method comprises the steps of: performing security negotiation between a first node included in a first communication network having the network address translation-protocol translation function and a second node included in a second communication network operating with a protocol different from the first communication network; storing protocol translation information generated when the security negotiation is performed in the first node; and performing security transmission between the first and second nodes using the stored protocol translation information.

The method may further include the step of performing authentication between the first and second nodes using the stored protocol translation information.

Performance of the authentication may include: predicting, at the first node, address information to be translated on the basis of the previously stored protocol translation information; generating, at the first node, authentication information on the basis of the predicted address information; transmitting the authentication information to the second node; authenticating, at the second node, the first node on the basis of the authentication information; generating, at the second node, authentication information on the basis of the address information of the second node; transmitting the authentication information to the first node; predicting, at the first node, translation address information of the first node on the basis of the previously stored protocol translation information; and authenticating, at the first node, the second node using the predicted translation address information and the authentication information transmitted from the second node.

Further, performing the security negotiation and storing the protocol translation information may include: translating, at a translation server for the network address and protocol translation, a protocol of a request message for the security negotiation so as to transmit the translated protocol to the second node in response to a request for the security negotiation of the first node; transmitting, at the translation server, the protocol translation information to the first node in response to a response message for security negotiation from the second node; storing, at the first node, the protocol translation information; and translating, at the translation server, a protocol of the security negotiation response message so as to transmit the translated protocol to the first node.

Further, performing the security transmission may include: calculating, at the first node, an integrity check value on the basis of the previously stored protocol translation information; generating an authentication header including the integrity check value; generating packet data including the authentication header so as to transmit the packet data to the second node; receiving, at the first node, the packet data including the authentication header from the second node; calculating, at the first node, the integrity check value on the basis of the previously stored protocol translation information in response to the reception of the packet data; and verifying the received packet data using the integrity check value.

In addition, performing the security transmission may include: predicting and calculating, at the first node, a Transmission Control Protocol/User Datagram Protocol (TCP/UDP) checksum value on the basis of the previously stored protocol translation information; generating, at the first node, the encapsulating security payload using the predicted and calculated TCP/UDP checksum value; transmitting the packet data having the encapsulating security payload to the second node; receiving, at the first node, the packet data having the encapsulating security payload from the second node; predicting and calculating, at the first node, the TCP/UDP checksum value on the basis of the previously stored protocol translation information in response to the reception of the packet data; and verifying the received packet data using the predicted and calculated TCP/UDP checksum value.

Furthermore, the first communication network may be an IPv6 network and the second communication network may be an IPv4 network, the protocol translation information may be IP header translation information between an IPv6 packet and an IPv4 packet, and the security service may make use of IPsec.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a processing flow chart of a method for providing end-to-end security service according to one embodiment of the present invention;

FIG. 2 illustrates a process wherein data are transmitted between nodes in order to provide end-to-end security service in accordance with one embodiment of the present invention;

FIG. 3 illustrates an example of the structure of a message of IP header translation information transmitted from a NAT-PT server to a NAT-PT node in order to provide end-to-end security service in accordance with one embodiment of the present invention;

FIG. 4 illustrates an example of the structure of a mapping table in which an NAT-PT server provides end-to-end security service in accordance with one embodiment of the present invention;

FIGS. 5 through 7 illustrate processes that are performed at an NAT-PT server on performing security negotiation for providing end-to-end security service according to one embodiment of the invention;

FIG. 8 illustrates a process that is performed at an NAT-PT node on performing security negotiation for providing end-to-end security service in accordance with one embodiment of the present invention;

FIGS. 9 and 10 illustrate examples of an end-to-end security transmission process in accordance with one embodiment of the present invention;

FIG. 11 is a view for explaining ICV required for authentication on performing an end-to-end security transmission process in accordance with one embodiment of the present invention;

FIGS. 12 through 14 illustrate processes that are performed at an NAT-PT server on performing an end-to-end security transmission process in accordance with one embodiment of the present invention;

FIG. 15 illustrates a process that is performed at an NAT-PT node on performing an end-to-end security transmission process in accordance with one embodiment of the present invention; and

FIGS. 16 and 17 illustrate examples of an end-to-end security transmission process in accordance with another embodiment of the present invention.

### DETAILED DESCRIPTION OF THE INVENTION

Hereinafter, an exemplary embodiment of the present invention will be described in more detail with reference to the accompanying drawings. It should be noted that, in the drawings, the same or similar components are designated by similar reference numerals or symbols even though represented in plural drawings. Further, in describing the invention, if it is determined that the detailed description of known functions or configurations makes the gist of the invention unnecessarily ambiguous, the detailed description will be omitted.

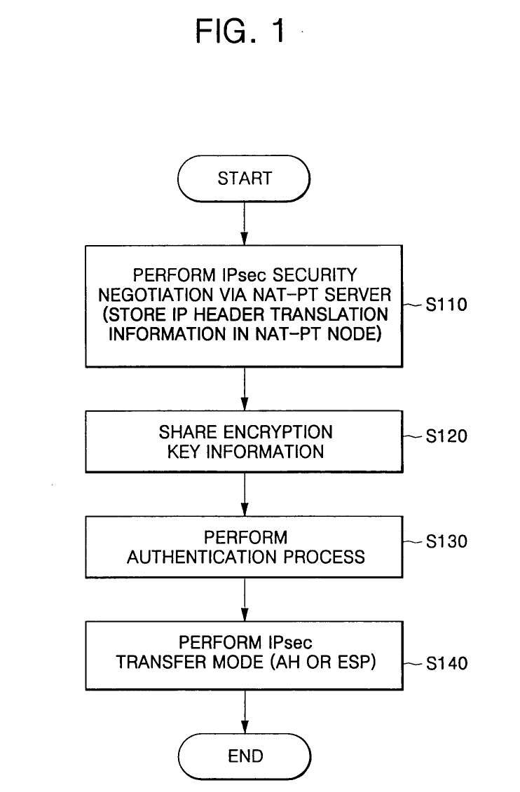

FIG. 1 is a processing flow chart of a method for providing end-to-end security service according to one embodiment of the present invention. Specifically, FIG. 1 is a processing flow chart of a method for providing end-to-end security service using IPsec in an IPv6 (Internet Protocol version 6) network having an Network Address Translation-Protocol Translation (NAT-PT) function. Here, the term ‘end-to-end security service’ refers to a service capable of sending data between ends in maintenance of security, which is equally applied to the following.

Referring to FIG. 1, in order to send data to which security is applied by the use of IPsec, an IPv6 host (hereinafter, referred to as an “NAT-PT node”) included in the IPv6 network having the NAT-PT function and an IPv4 host (hereinafter, referred to as an “IPv4 node”) included in an Internet Protocol version 4 (IPv4) network should first perform Internet Protocol Security (IPsec) security negotiation (S110). In other words, the NAT-PT node and the IPv4 node perform a procedure for determining a framework (security association (SA)) for encryption or authentication (e.g., an encryption algorithm). In this case, to make it possible to recognize the corresponding NAT-PT node on the IPv4 network, an NAT-PT server allocates an IPv4 address to the NAT-PT node, translates an IP header of the corresponding packet by the use of the IPv4 address, and transmits the translated packet to the IPv4 node. The NAT-PT server transmits information related to the IP header translation to the NAT-PT node, thereby allowing the NAT-PT node to store the IP header translation information.

Further, the NAT-PT and IPv4 nodes perform a procedure for sharing information on a key (e.g., information on an encryption key) for encryption and authentication of the encrypted information on the basis of a result of performing the security negotiation (S 120). For example, when the NAT-PT node sets the encryption key and then transmits the encryption key to the IPv4 node through the NAT-PT node, the IPv4 node stores the encryption key and then transmits the encryption key back to the NAT-PT node.

In this manner, the NAT-PT and IPv4 nodes share the SA information and the encryption key with each other, and then perform an authentication process using the SA information and the encryption key (S130). For example, when the NAT-PT node transmits information related to the encrypted header and the authentication to the IPv4 node by the use of the encryption key stored in the NAT-PT node, the IPv4 node authenticates the NAT-PT node on the basis of the header and authentication information received from the NAT-PT node. Similarly, when the IPv4 node transmits information related to the encrypted header and the authentication to the NAT-PT node by the use of the encryption key stored in the IPv4 node, the NAT-PT node authenticates the IPv4 node on the basis of the header and authentication information received from the IPv4 node.

When authentication between the NAT-PT and IPv4 nodes is completed by the authentication process (S130), an IPsec transfer mode is performed between the NAT-PT and IPv4 nodes (S140). In other words, data to which IPsec security is applied are transmitted between the NAT-PT and IPv4 nodes. In this regard, IPsec provides two kinds of security services: an authentication header (AH), which allows authentication of the transmitter of data; and an encapsulating security payload (ESP), which supports both authentication of the transmitter and encryption of data. Therefore, in the transfer mode process (S140), an IPsec transfer mode based on the AH or the ESP is performed.

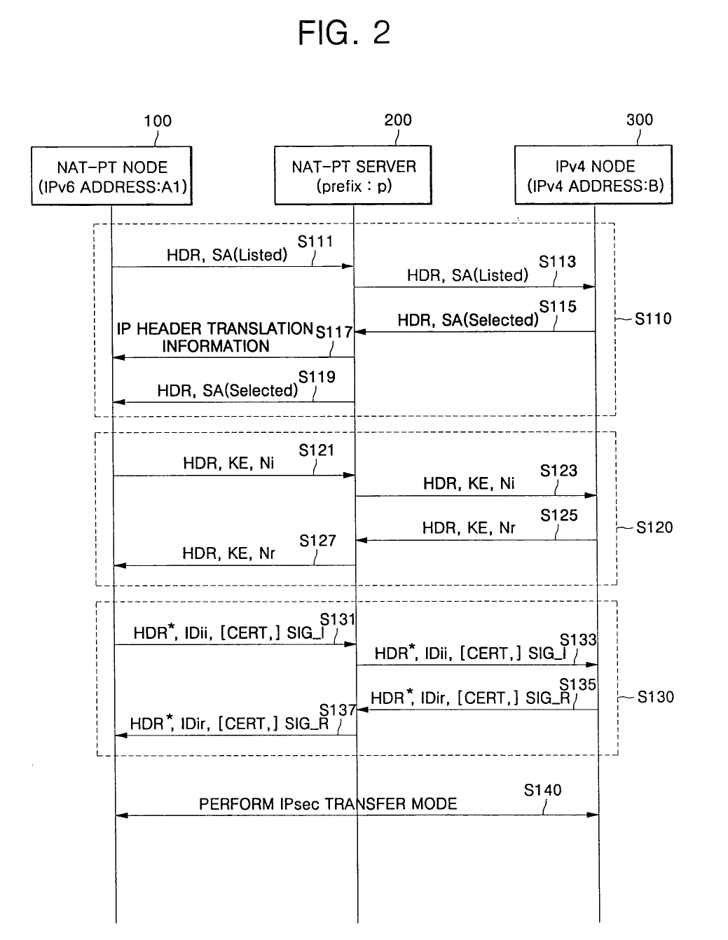

FIG. 2 illustrates a process wherein data are transmitted between nodes in order to provide end-to-end security service in accordance with one embodiment of the present invention. Particularly, FIG. 2 illustrates a procedure wherein data are transmitted between an NAT-PT node 100, an NAT-PT server 200, and an IPv4 node 3 00 in order to provide end-to-end security service by the use of IPsec in an IPv6 network having an NAT-PT function.

Referring to FIG. 2, in order to send data to which security is applied using IPsec, the NAT-PT node 100 and the IPv4 node 300 perform the process of performing the security negotiation (S110), the process of sharing the encryption key information (S120), the process of performing authentication (S130), and the process of performing IPsec transfer mode (S140), which have been described with reference to FIG. 1. The following description will be made with regard to a process of sending the data between the NAT-PT node 100 and the IPv4 node 300 in each process.

First, in the process of performing the security negotiation (S110), the process of sending the data is as follows.

The NAT-PT node 100 makes up an IKE (Internet Key Exchange) payload in which information relating to a header (HDR) and an SA is included in order to perform IKE negotiation, generates an IPv6 packet including the IKE payload, and then transmits the IPv6 packet to the NAT-PT server 200 (S111). Thus, the NAT-PT server 200 allocates an IPv4 address to an NAT-PT node 100, and then translates the IPv6 packet into an IPv4 packet on the basis of the IPv4 address. And the NAT-PT server 200 transmits the translated IPv4 packet to the IPv4 node 300 (S113). However, if the IPv4 address allocated to the NAT-PT node 100 already exists in an address mapping table stored in the NAT-PT server 200, the process of allocating the IPv4 address can be omitted. In other words, the packet translation is performed on the basis of the IPv4 address registered with the address mapping table.

At this time, in the above-mentioned processes S111 and S113, the transmitted IP packet simply has a different format (IPv6 or IPv4), but the transmitted data are identical. That is to say, the HDR and SA information are transmitted. Above all, in the case of the SA information, the many pieces of SA information are preferably transmitted in a list form such that the IPv4 node 300 makes a selection from them.

Meanwhile, the IPv4 node 300 receiving the IKE payload, with the HDR and SA information, from the NAT-PT server 200 makes up the IKE payload in which the HDR and SA information are included in order to perform an IKE negotiation with the NAT-PT node 100, generates the IPv4 packet including the IKE payload, and then transmits the IPv4 packet to the NAT-PT server 200 (S115).

Thus, the NAT-PT server 200 transmits information relating to the IP header translation to the NAT-PT node 100 for the process S 113, wherein the IP header translation has been performed at the NAT-PT server 200 (S117).

The NAT-PT server 200 translates the IPv4 packet transmitted in the process S115 into the IPv6 packet on the basis of the previously stored address mapping table, and then transmits the IPv6 packet to the NAT-PT node 100 (S119).

At this time, in the above-mentioned processes S115 and S119, the transmitted IP packet simply has a different format (IPv6 or IPv4), but the transmitted data are identical. That is to say, the HDR and SA information are transmitted. Especially, in the case of the SA information, it is preferably selected from the many pieces of SA information transmitted from the NAT-PT node 100 via the IPv4 node 300.

Most preferably, the process S117 is performed between the processes S115 and S119, as illustrated in FIG. 2, but the invention is not limited to that sequence. In other words, it does not matter that the process S117 is performed at any time between the processes S111 and S119. To be specific, it will suffice if the process S117 is performed at any time after initiation of the security negotiation for IPsec and before the operation of authentication information by the use of the address information of the NAT-PT node 100.

The data sending process in the process of sharing encryption key information (S120) is as follows.

The NAT-PT node 100 makes up an IKE payload in which information related to HDR, key exchange (KE) and temporary random number value Ni are included, generates an IPv6 packet including the IKE payload, and then transmits the IPv6 packet to the NAT-PT server 200 (S121). Thus, the NAT-PT server 200 translates the IPv6 packet into an IPv4 packet on the basis of the IPv4 address registered with the address mapping table, and transmits the translated IPv4 packet to the IPv4 node 300 (S123).

At this time, in the above-mentioned processes S121 and S123, the transmitted IP packet simply has a different format (IPv6 or IPv4), but the transmitted data are identical. That is to say, the HDR, KE and Ni are transmitted.

Meanwhile, the IPv4 node 300 receiving the IKE payload with the included HDR, KE and Ni from the NAT-PT server 200 makes up an IKE payload in which HDR, KE and Nr are included, generates the IPv4 packet including the IKE payload, and then transmits the IPv4 packet to the NAT-PT server 200 (S125). Thus, the NAT-PT server 200 translates the IPv4 packet into the IPv6 packet on the basis of the previously stored address mapping table, and transmits the translated IPv6 packet to the NAT-PT node 100 (S127).

At this time, in the above-mentioned processes S125 and S127, the transmitted IP packet simply has a different format (IPv6 or IPv4), but the transmitted data are identical. That is to say, the HDR, KE and Nr are transmitted.

The data sending process in the process of performing authentication (S130) is as follows.

The NAT-PT node 100 generates address information IDii and authentication information [CERT,] SIG_I, and encrypts the generated information and HDR information together by use of the key information KE shared in the course of performing the processes S110 and S120. Then, the NAT-PT node 100 makes up an IKE payload including the information, generates an IPv6 packet including the IKE payload, and then transmits the IPv6 packet to the NAT-PT server 200 (S131). At this time, in order for the IPv4 node 300 to perform successful authentication to the NAT-PT node 100, the NAT-PT node 100 generates address information IDii by means of the IP header translation information received through the process S117, rather than the its own IPv6 address, as well as authentication information [CERT,] SIG_I, and adds the address information and the authentication information to the IKE payload. This is for the purpose of allowing the NAT-PT server 200 to authenticate the NAT-PT node 100 using the IPv4 address which the NAT-PT server 200 allocates to the NAT-PT node 100 in the IPv4 network. The NAT-PT server 200, receiving the IPv6 packet through the process S131, translates the IPv6 packet into an IPv4 packet on the basis of the IPv4 address registered with the address mapping table, and the transmits the translated IPv4 packet to the IPv4 node 300 (S133).

At this time, in the above-mentioned processes S131 and S133, the transmitted IP packet simply has a different format (IPv6 or IPv4), but the transmitted data are identical. That is to say, in the above-mentioned processes S131 and S133, the address information IDii generated by means of the IP header translation information received through the process S117, as well as the authentication information [CERT, ] SIG_I, are transmitted.

Meanwhile, the IPv4 node 300, receiving the IPv4 packet from the NAT-PT server 200 through the process S133, authenticates the NAT-PT node 100 on the basis of the received information (e.g., the address information IDii, the authentication information [CERT, ] SIG_I, etc.). In addition, the IPv4 node 300 generates its own address information IDir as well as authentication information [CERT, ] SIG_R on which the address information IDir is reflected, and encrypts the generated information and HDR information together by the use of the key information KE shared in the course of performing the processes S110 and S120. Then, the IPv4 node 300 makes up an IKE payload including the information, generates an IPv4 packet including the IKE payload, and then transmits the IPv4 packet to the NAT-PT server 200 (S135).

The NAT-PT server 200 then translates the IPv4 packet, transmitted in the process S135, into an IPv6 packet on the basis of the previously stored address mapping table, and then transmits the translated IPv6 packet to the NAT-PT node 100 (S137).

The NAT-PT node 100 receiving the information authenticates the IPv4 node 300 by use of the address information IDir and the authentication information [CERT, ] SIG_R included in the IPv6 packet transmitted through the process S137. In this case, when a prefix of a source address included in the received IPv6 packet matches a prefix included in the IP translation information, the NAT-PT node 100 performs authentication to the IPv4 node 300 using other address portions, except the prefix of the source address included in the IPv6 packet.

The process of performing authentication (S130) has been described with respect to the case wherein each node serving as a target for authentication performs authentication using the address information of the counter node, but the invention is not limited thereto. For example, when the address information of the authentication target nodes is not used for the process of performing authentication (S130), each node can perform authentication without using the IP header translation information.

When authentication is completed between the NAT-PT node 100 and the IPv4 node 300 by means of a series of processes S131 to S137, an IPsec transfer mode is performed between the NAT-PT node 100 and the IPv4 node 300 (S140).

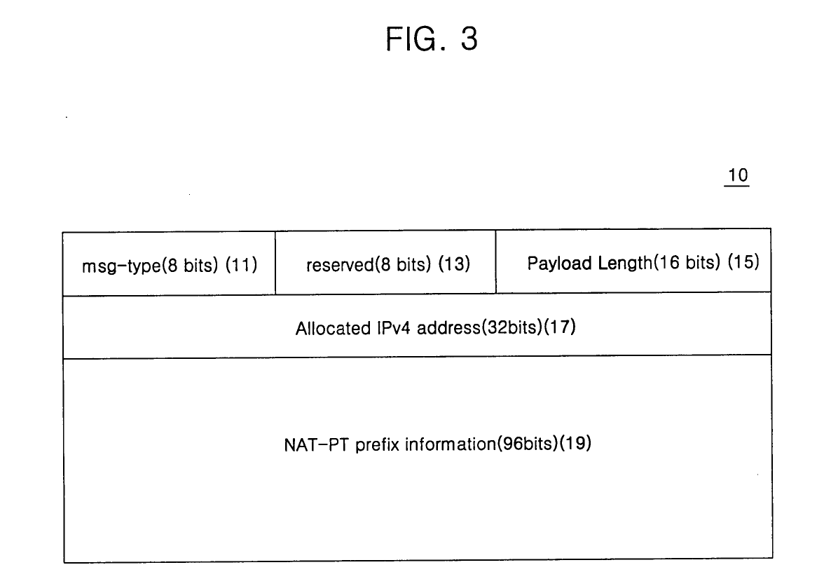

FIG. 3 illustrates an example of the structure of a message of IP header translation information transmitted from a NAT-PT server to a NAT-PT node in order to provide end-to-end security service in accordance with one embodiment of the present invention. Specifically, FIG. 3 illustrates an example of the structure of a message of the IP header translation information transmitted from the NAT-PT server 200 to the NAT-PT node 100 through the process S117 of FIG. 2. Referring to FIG. 3, the message 10 for the IP header translation information is composed of a plurality of fields: msg-type (8 bits) serving as a message type field 11; reserved (8 bits) serving as a reserved field 13; payload length (16 bits) serving as a payload length information field 15; allocated IPv4 address (32 bits) serving as an IPv4 address field 17 allocated to the corresponding NAT-PT node (e.g., IPv6 node); and NAT-PT prefix information (96 bits) serving as an NAT-PT prefix information field 19.

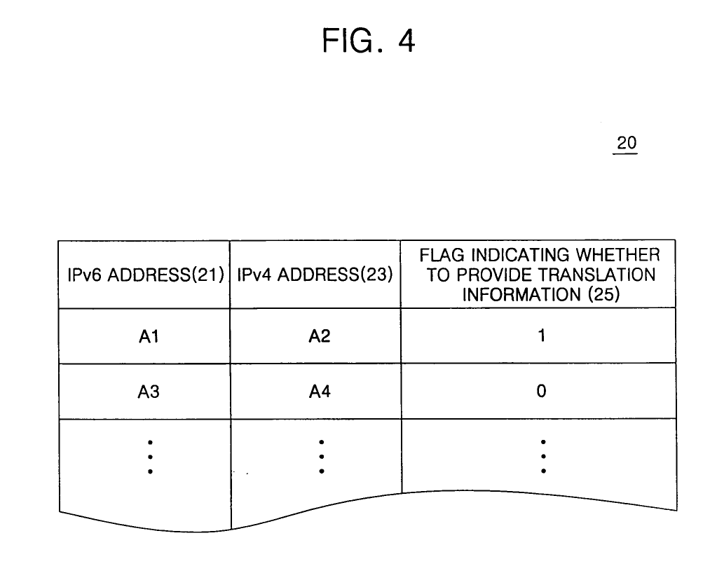

FIG. 4 illustrates an example of the structure of a mapping table in which an NAT-PT server provides end-to-end security service in accordance with one embodiment of the present invention. Specifically, FIG. 4 illustrates an example of the structure of an address mapping table 20 that is stored in an NAT-PT server 200 in order to provide end-to-end security service using IPsec in an IPv6 network having an NAT-PT function.

Referring to FIG. 4, the address mapping table 20 is composed of an IPv6 address field 21 for storing an IPv6 address of the NAT-PT node, an IPv4 address field 23 for storing an IPv4 address allocated to the corresponding NAT-PT node, and a flag field 25 for indicating whether IP translation information of the corresponding session is provided. The flag field 25 is provided for indicating whether information on IPv4 address allocation is transmitted to the corresponding NAT-PT node. For example, if a value of 1(one) is stored in the flag field 25, it means that the IP translation information of the corresponding session is transmitted to the corresponding NAT-PT node. If a value of 0(null) is stored in the flag field 25, it means that the IP translation information of the corresponding session is not transmitted to the corresponding NAT-PT node.

Referring to the address mapping table of FIG. 4, it can be seen that the NAT-PT server allocates the IPv4 address ‘A2’ to the NAT-PT node n1 having the IPv6 address ‘A1,’ allocates the IPv4 address ‘A4’ to the NAT-PT node n2 having the IPv6 address ‘A3,’ transmits the IP translation information to the NAT-PT node n1, and does not send the IP translation information to the NAT-PT node n2.

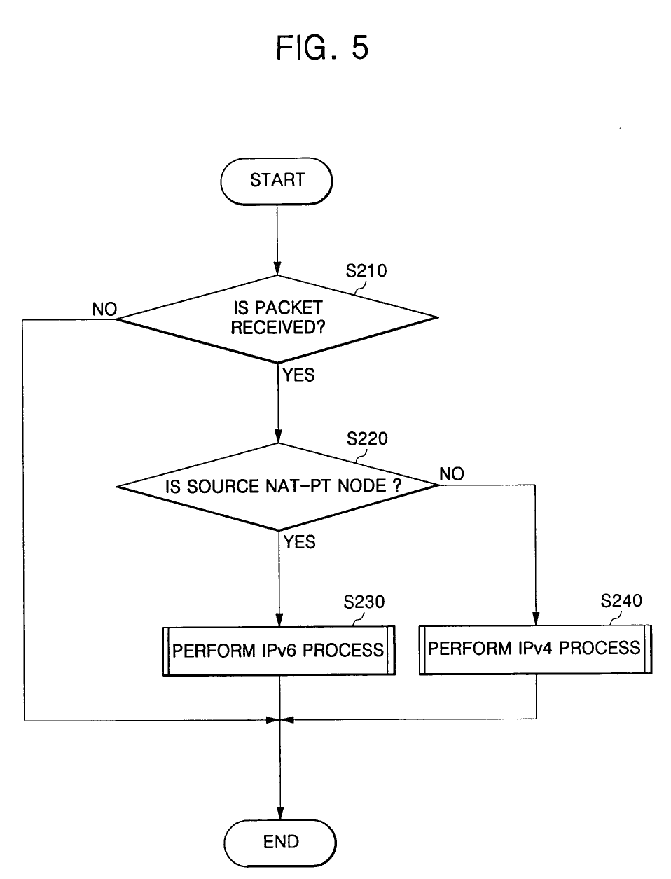

FIGS. 5 through 7 illustrate processes that are performed at an NAT-PT server on performing security negotiation for providing end-to-end security service according to one embodiment of the invention. Particularly, FIGS. 5 through 7 illustrate processes that are performed at an NAT-PT server on performing security negotiation for providing end-to-end security service using IPsec in an IPv6 network having an NAT-PT function.

Referring to FIG. 5, when the NAT-PT server receives a packet for security negotiation (S210), the NAT-PT server determines whether a source of the packet is the NAT-PT node or the IPv4 node (S220). For example, preferably, the NAT-PT server checks a source address of the packet, thereby determining whether the source of the packet is the NAT-PT node or the IPv4 node. Specifically, when the source address of the received packet is the IPv6 address, the NAT-PT server determines the source to be the NAT-PT node. When the source address of the received packet is the IPv4 address, the NAT-PT server determines the source to be the IPv4 node.

As a result of the determination of the process S220, when the source of the received packet is the NAT-PT node, the NAT-PT server performs an IPv6 process (S230). However, when the source of the received packet is the IPv4 node, the NAT-PT server performs an IPv4 process (S240).

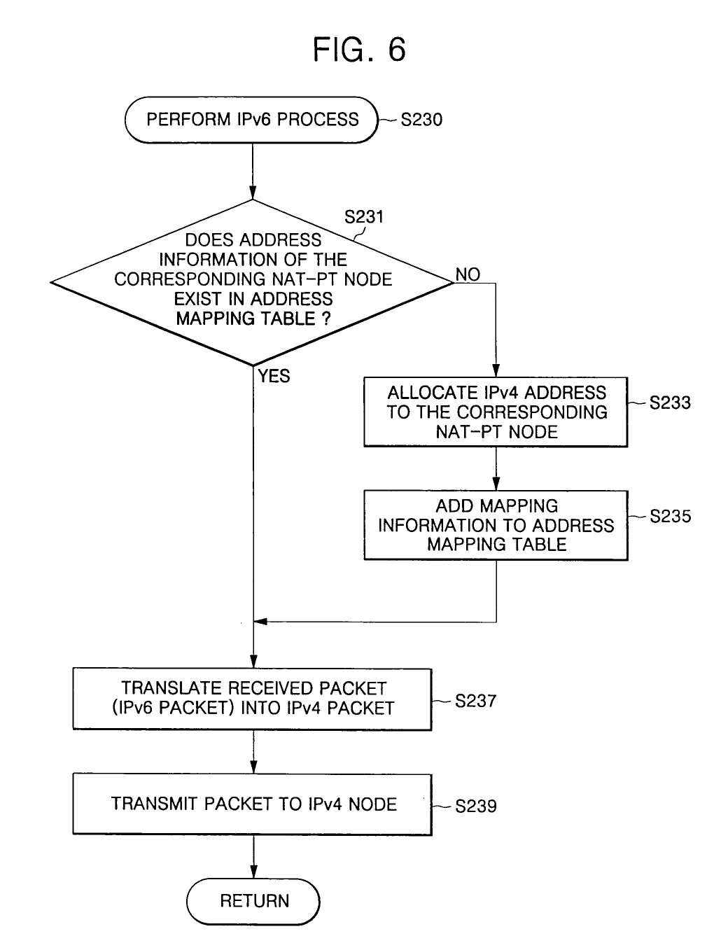

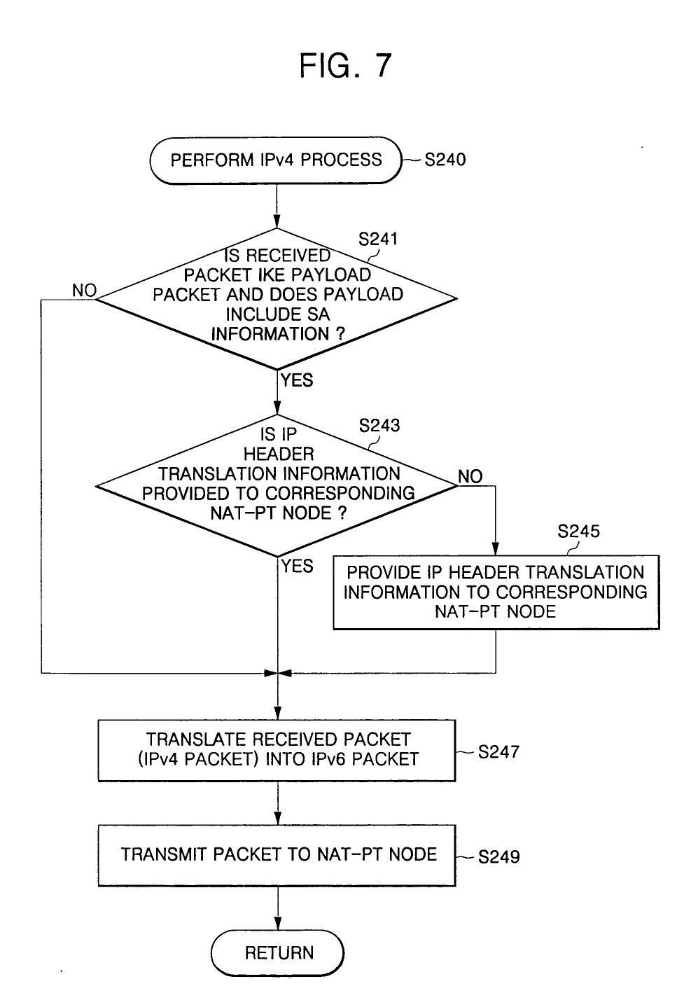

Details of the processes S230 and S240 are illustrated in FIGS. 6 and 7, respectively. Specifically, FIG. 6 illustrates an example of the IPv6 process S230, and FIG. 7 illustrates an example of the IPv4 process S240.

Hereinafter, the IPv6 process S230 will be described with reference to FIGS. 5 and 6.

First, the NAT-PT node determines whether address information of the corresponding NAT-PT node exists in the address mapping table having the configuration illustrated in FIG. (S231). Specifically, it is determined whether a source (NAT-PT node) address of the IPv6 packet, received in the process S210, exists in the address mapping table.

When the address information of the corresponding NAT-PT node exists in the address mapping table, the received packet (IPv6 packet) is translated into an IPv4 packet (S237). In other words, an IPv4 address is allocated to the corresponding NAT-PT node using information stored in the address mapping table, and a header of the received packet is translated using the IPv4 address.

The translated IPv4 packet is transmitted to the IPv4 node corresponding to a destination address of the received packet (S239).

If, as a result of the determination of the process S231, the address information of the corresponding NAT-PT node is determined not to exist in the address mapping table, a process of allocating the IPv4 address to the corresponding NAT-PT node (S233) and a process of adding mapping information (S235), for example, between the IPv6 address of the NAT-PT node and the IPv4 address allocated to the NAT-PT node, are further performed.

Now, the IPv4 process S240 will be described with reference to FIGS. 5 and 7.

First, the NAT-PT server determines whether the IPv4 packet received in the process S210 is a packet including an IKE payload, and whether the IKE payload includes SA information (S241). In other words, it is determined whether the received packet is a packet for performing end-to-end security negotiation of the IPv6 network.

If, as a result of the determination of the process S241, the corresponding packet is determined to be the packet for the end-to-end security negotiation, the NAT-PT server determines whether IP header translation information is provided to the corresponding NAT-PT node (S243). In other words, the NAT-PT server determines whether the IP header translation information of the NAT-PT node is provided to the NAT-PT node which is in the course of performing the security negotiation with the IPv4 node sending the IPv4 packet.

If, as a result of the determination of the process S243, it is determined that the IP header translation information is not provided to the corresponding NAT-PT node, the NAT-PT server provides the IP header translation information to the corresponding NAT-PT node (S245), and then translates the packet (IPv4 packet) into the IPv6 packet (S247). Specifically, the NAT-PT server translates a source address of the packet (IPv4 packet) into an IPv6 address using a value of a NAT-PT prefix that is previously set for the NAT-PT server, and translates a destination address of the packet (IPv4 packet) into the IPv6 address using information stored in the address mapping table. The NAT-PT server then transmits the translated IPv6 packet to the NAT-PT node corresponding to the destination address of the received packet (S249).

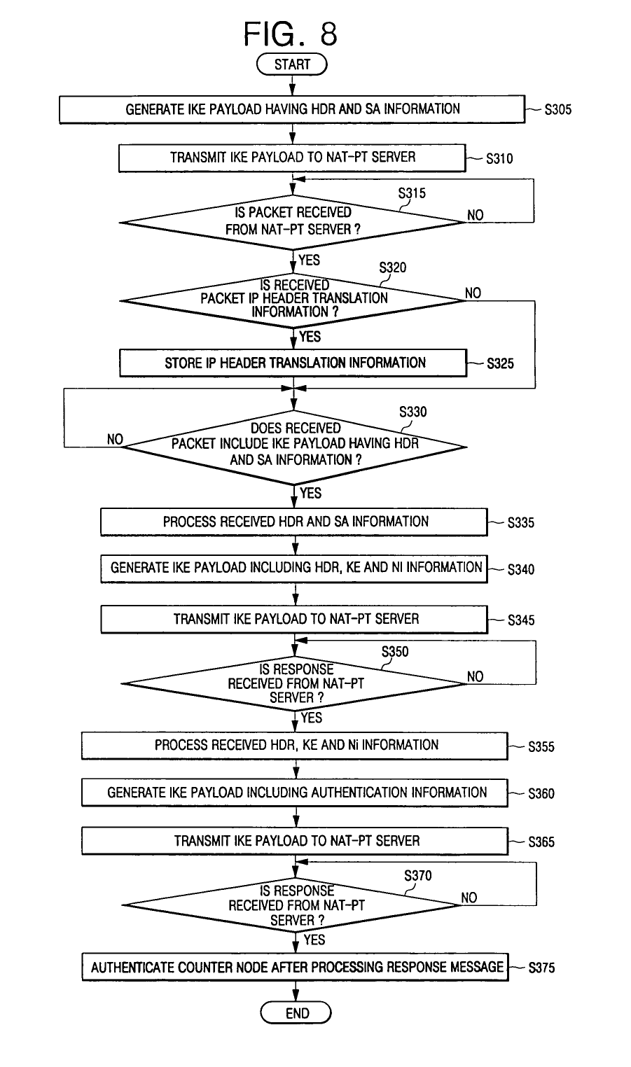

FIG. 8 illustrates a process that is performed at an NAT-PT node on performing security negotiation for providing end-to-end security service in accordance with one embodiment of the present invention. Particularly, FIG. 8 illustrates a process that is preformed at an NAT-PT node on performing security negotiation for providing end-to-end security service using IPsec in an IPv6 network having an NAT-PT function.

Referring to FIG. 8, the NAT-PT node first generates an IKE payload including HDR and SA information (S305), and then transmits the IKE payload to the NAT-PT server (S310). When a packet is received from the NAT-PT server (S315), the NAT-PT node determines whether the received packet is IP header translation information (S320). When the received packet is the IP header translation information, the NAT-PT node stores the IP header translation information (S325).

The NAT-PT node determines whether the received packet includes the IKE payload with HDR and SA information (S330). When the received packet includes the IKE payload with HDR and SA information, the NAT-PT node processes the HDR and SA information (S335). In other words, the NAT-PT node sets encryption information (e.g., encryption algorithm, etc.) on the basis of the HDR and SA information received from the NAT-PT server.

Further, the NAT-PT node generates an IKE payload including HDR, KE and Ni (a value of a temporary random number) so as to share an encryption key with the counter node (e.g., IPv4 node) through the NAT-PT server (S340), and then transmits the IKE payload to the NAT-PT server (S345). When the NAT-PT node receives a response (e.g., an IKE payload including HDR, KE and Nr, a value of another temporary random number) from the NAT-PT server (S350), it processes the received response (information on the HDR, KE and Nr) (S355).

Meanwhile, the NAT-PT node generates an IKE payload including authentication information in order to perform authentication to the counter node (S360), and then transmits the IKE payload to the NAT-PT server (S365). When the NAT-PT node receives a response from the NAT-PT server (S370), it processes the response message to authenticate the counter node (S375). For example, the NAT-PT node generates address information IDii and authentication information [CERT, ] SIG_I, and encrypts the generated information together with HDR information using key information KE shared with the counter node. Then, the NAT-PT node generates an IKE payload including the information, and transmits the IKE payload to the NAT-PT server. The NAT-PT node receives an IKE payload including encrypted HDR*, IDir and [CERT, ] SIG-R from the counter node through the NAT-PT, and processes the encrypted HDR*, IDir and [CERT,]SIG_R to authenticate the counter node.

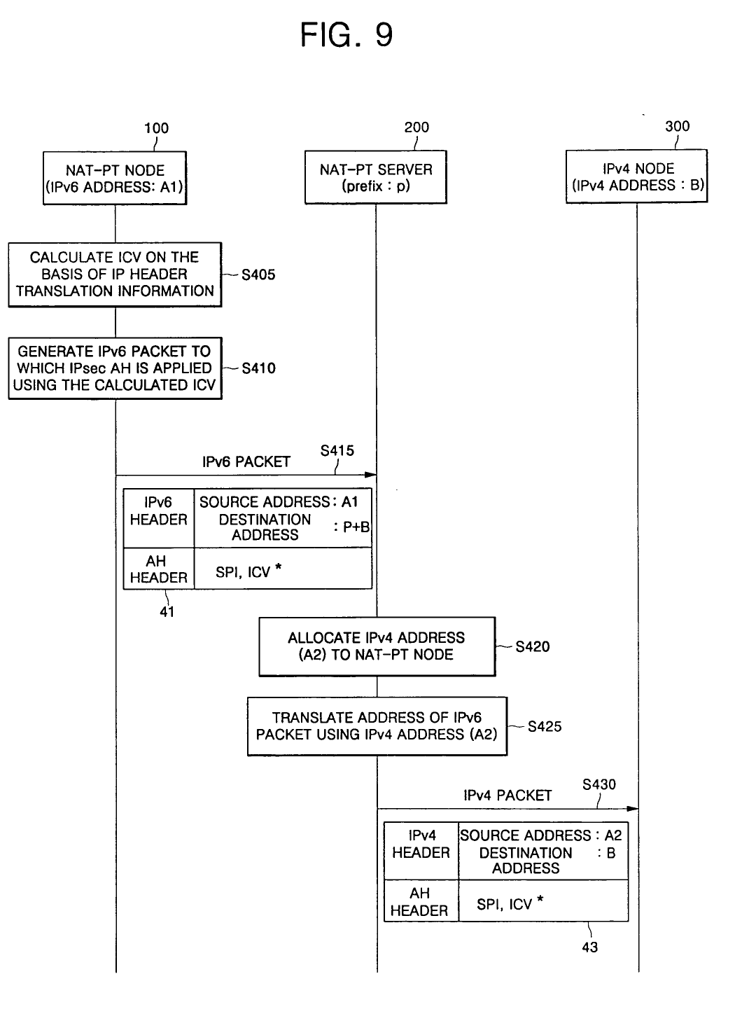

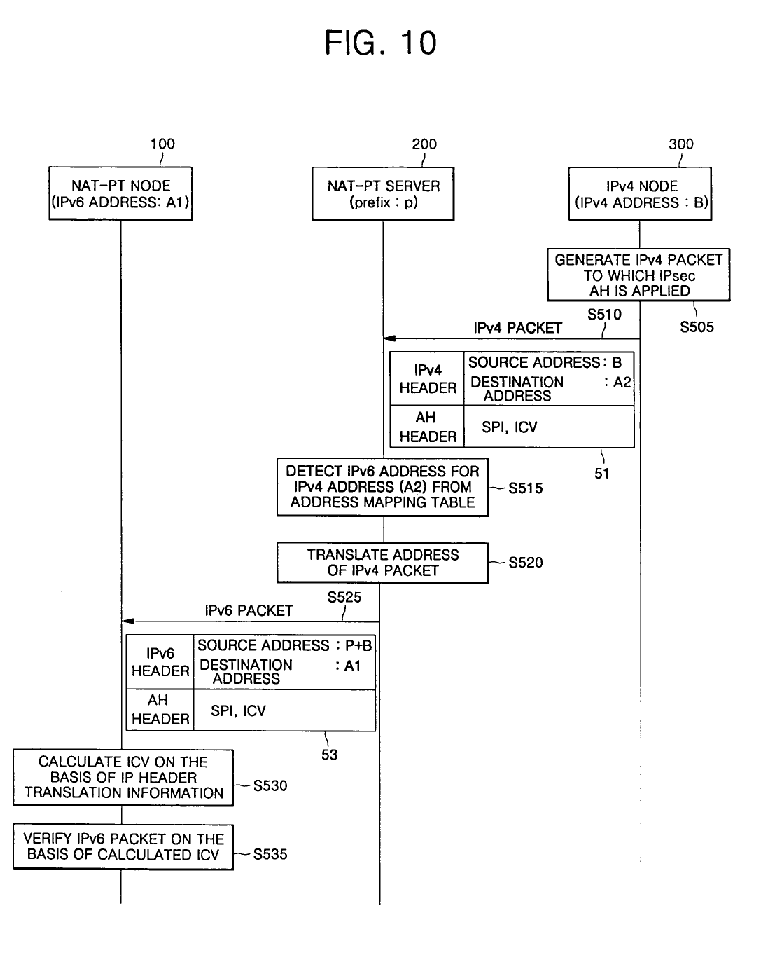

FIGS. 9 and 10 illustrate examples of an end-to-end security transmission process in accordance with one embodiment of the present invention. Particularly, FIGS. 9 and 10 illustrate the processes of performing security transmission between an NAT-PT node 100 and an IPv4 node 300 using an IPsec transfer mode by AH in an IPv6 network having a NAT-PT function. Here, it is assumed that an IPv6 address of the NAT-PT node 100 is ‘A1,’ that an NAT-PT prefix is ‘p,’ and that an IPv4 address of the IPv4 node 300 is ‘B’. Therefore, FIG. 9 illustrates a process wherein the NAT-PT node 100 transmits packet data using the IPsec transfer mode by AH, and FIG. 10 illustrates a process where the NAT-PT node 100 verifies the received packet data using the IPsec transfer mode by AH.

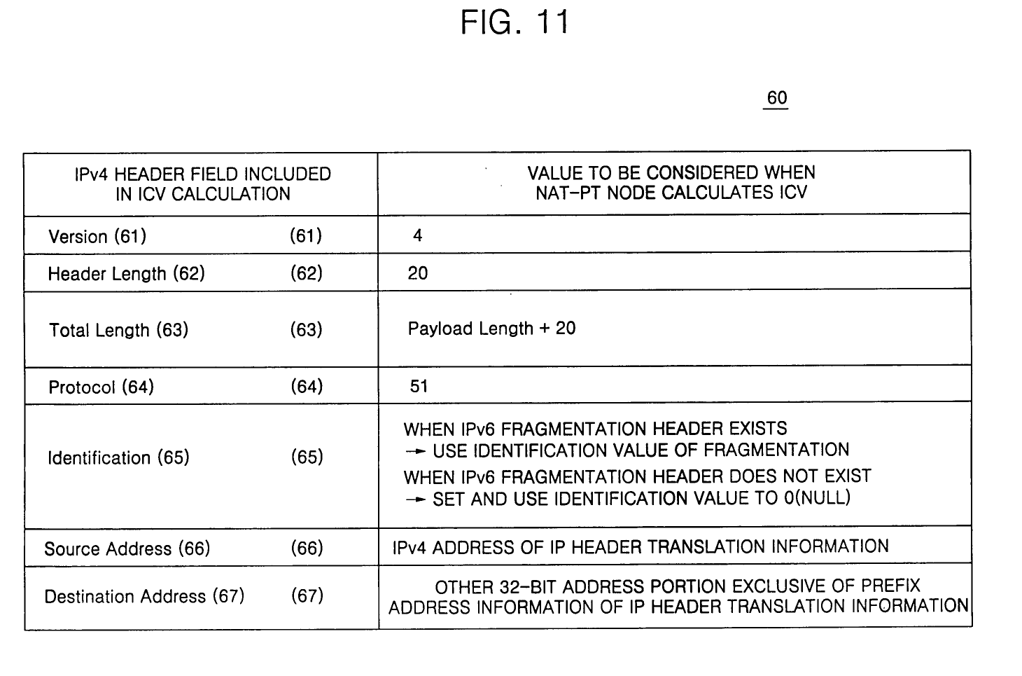

Referring to FIG. 9, the NAT-PT node 100 calculates an integrity check value (ICV) on the basis of the IP header translation information that is previously stored in the processes of performing security negotiation (e.g., the process S110 of FIGS. 1 and 2 and the process S325 of FIG. 8) (S405). The ‘ICV’ is a value for authenticating whether a frame is varied during transmission of a data frame, which value is calculated using an invariable value within an IPv4 header field. The IPv4 header field used to calculate the ICV will be described below with reference to FIG. 11.

When the ICV is calculated in the process S405, the NAT-PT node 100 generates an IPv6 packet to which an IPsec AH is applied using the ICV (S410), and then transmits the IPv6 packet to the NAT-PT server 200 (S415). The IPv6 packet to which the IPsec AH is applied is one including an AH header, which refers to a packet transmitted by the use of an IPsec transfer mode by AH. An example of the IPv6 packet is illustrated by reference number 41 in FIG. 9. Referring to the reference number 41, the IPv6 packet to which the IPsec AH is applied, and which is generated in the process S410, includes an IPv6 header having a source IPv6 address A1, a destination IPv6 address P+B, and an AH header having SPI (Security Parameter Index) and ICV* (encrypted ICV).

The NAT-PT server 200 receiving the IPv6 packet, to which the IPsec AH is applied, allocates the IPv4 address to the NAT-PT node 100 on the basis of the previously stored address mapping table (S420). For example, according to what is illustrated in FIG. 4, when the IPv6 address is ‘A1,’ the NAT-PT server 200 allocates the IPv4 address ‘A2’ to the NAT-PT node 100 because the IPv4 address A2 is mapped.

The NAT-PT server 200 translates an address of the IPv6 packet using the IPv4 address A2 to generate an IPv4 packet (S425), and transmits the IPv4 packet to the IPv4 node 300 (S430). For example, the NAT-PT server 200 translates the source IPv6 address into the IPv4 address allocated in the process S420, removes an NAT-PT prefix P from the destination IPv6 address P+B, and translates the IPv6 packet into the IPv4 packet. An example of the IPv4 packet transmitted in the process S430 is illustrated by a reference number 43 in FIG. 9.

In order to transmit packet data to the IPv4 node 300 using the IPsec transfer mode by AH, the NAT-PT node 100 of the present invention calculates ICV to be included in an AH header using the IP header translation information that is previously stored (i.e., information on the IPv4 address allocated to the NAT-PT node 100).

A process wherein the NAT-PT node 100 receives packet data using the IPsec transfer mode by AH and verifies the packet data will be described with reference to FIG. 10.

First, the IPv4 node 300 generates an IPv4 packet to which an IPsec AH is applied (S505) and transmits the IPv4 packet to the NAT-PT server 200 (S510). The IPv4 packet to which the IPsec AH is applied is one having an AH header, similar to the IPv6 packet to which the IPsec AH is applied as described above with reference to FIG. 9, which refers to one transmitted using the IPsec transfer mode by AH. Examples are illustrated by a reference number 51 in FIG. 10. Referring to the reference number 51, the IPv4 packet to which the IPsec AH is applied includes an IPv4 header having a source IPv4 address B, a destination IPv4 address A2, and an AH header having SPI and ICV.

The NAT-PT server 200, receiving the IPv4 packet to which the IPsec AH is applied, detects the IPv6 address, which is mapped to the destination IPv4 address A2 included in the IPv4 packet, from the previously stored address mapping table (S515). For example, according to what is illustrated in FIG. 4, when the IPv4 address is ‘A2,’ the NAT-PT server 200 detects the IPv6 address Al because the IPv6 address A1 is mapped.

The NAT-PT server 200 translates an address of the IPv4 packet using the IPv6 address A1 to generate an IPv6 packet (S520), and transmits the IPv6 packet to the NAT-PT node 100 (S525). For example, the NAT-PT server 200 translates the source IPv4 address B into the IPv6 address P+B by addition of a NAT-PT prefix P, and translates the destination IPv4 address A2 using the IPv6 address detected in the process S515. An example of the IPv6 packet transmitted in the process S525 is illustrated by a reference number 53 in FIG. 10.

The NAT-PT node 100 receiving the IPv6 packet calculates ICV on the basis of the previously stored IP header translation information in order to verify the received IPv6 packet (S530). The ICV will be described in detail with reference to FIG. 11 below.

When the ICV is calculated in the process S530, the NAT-PT node 100 verifies the IPv6 packet to which the IPsec AH is applied using the ICV (S535). In other words, the IPv6 packet is verified by comparison of the calculated ICV with the ICV included in an AH header of the IPv6 packet.

FIG. 1 is a view for explaining ICV required for authentication on performing an end-to-end security transmission process in accordance with one embodiment of the present invention. Specifically, FIG. 11 illustrates values needed when ICV required for end-to-end authentication is calculated in the case of performing security transmission using an IPsec transfer mode by AH in an IPv6 network having an NAT-PT function.

Referring to FIG. 11, an IPv4 header field required to calculate the ICV is composed of a version field 61, a header length field 62 indicating a length of a header, a total length field 63, a protocol field 64, an identification field 65, a source address field 66, and a destination address field 67.

In order to perform security transmission using the IPsec transfer mode by AH in the IPv6 network, the NAT-PT node should separately set and store values of the respective fields using IP header translation information received from the NAT-PT server. This is to make the NAT-PT node either generate or verify a packet to which an IPsec AH is applied in the IPsec transfer mode by AH because an address of the NAT-PT node is translated into an IPv4 address in order to communicate with the IPv4 node.

FIG. 11 illustrates information that is set for the NAT-PT node with respect to the field values so as to perform the security transmission using the IPsec transfer mode by AH.

Referring to FIG. 11, a value of ‘4’ is stored in the version field 61. Information relating to an IPv4 header length is stored in the header length field 62. A value derived by adding ‘20’ to a payload length is stored in the total length field 63. This is due to the fact that the payload length of the IPv6 header field indicates only a size of an IP datagram. In other words, in order to indicate a total length of the IPv4 payload, a value of ‘20’ corresponding to a length of the IPv4 header should be added.

Further, an AH protocol value of ‘51’ is stored in the protocol field 64. Meanwhile, information on whether to use fragmentation of packet data is stored in the identification field 65. If a fragmentation header exists in the IPv6 header, an identification value of the fragmentation is used. However, if the fragmentation header does not exist in the IPv6 header, a value of ‘0(null)’ is used. This is because the identification value is not predicted at the NAT-PT server. For this reason, when the fragmentation header exists in the IPv6 header, the identification value of the fragmentation is used as it stands. If not, the identification value is set to ‘0’ in the sense of not permitting the fragmentation.

IPv4 addresses for source and destination addresses of packet data, in which the AH header is included, are stored in the source address field 66 and the destination address field 67, respectively.

In order to calculate ICV for inclusion in the packet data (IPv6 packet to which an IPsec AH is applied) to be transmitted to the IPv4 node, the NAT-PT node stores the IPv4 address of the IP header translation information in the source address field 66. In other words, the NAT-PT node stores the IPv4 address allocated from the NAT-PT server. An address of the IPv4 node (the IPv4 address subjected to removal of a NAT-PT prefix) is stored in the destination address field 67.

Meanwhile, when calculating the ICV for verification of the packet data received from the IPv4 node, the NAT-PT node stores, in the source address field 66, a value for removing the NAT-PT prefix from the source address (the IPv6 address of the IPv4 node) included in the received packet data, and stores the IPv4 address of the IP header translation information in the destination address field 67. In other words, the NAT-PT node stores the IPv4 address allocated from the NAT-PT server.

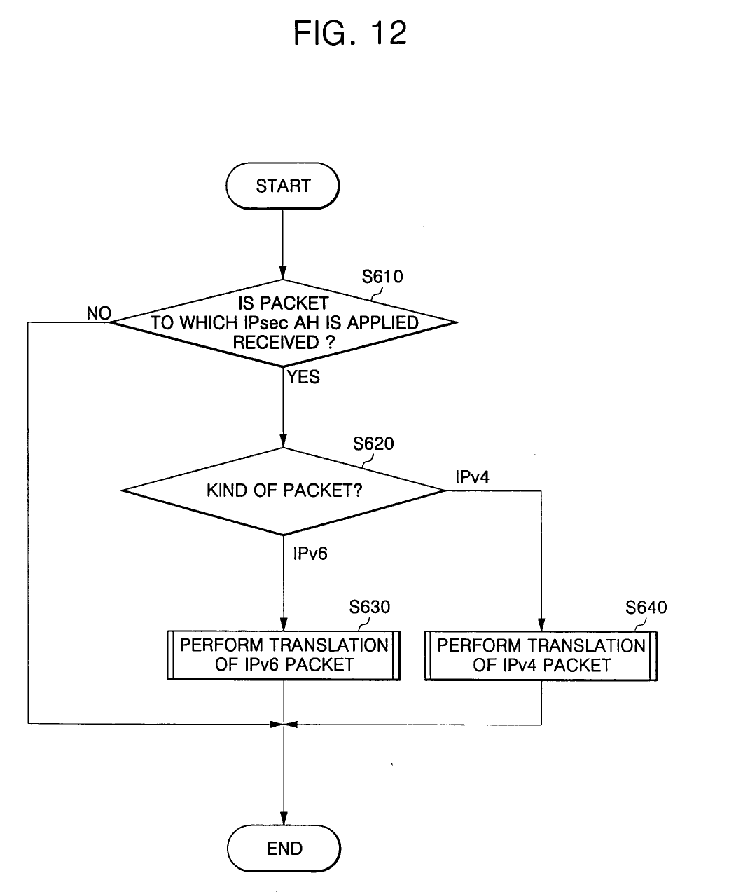

FIGS. 12 through 14 illustrate processes that are performed at an NAT-PT server on performing an end-to-end security transmission process in accordance with one embodiment of the present invention. Particularly, FIGS. 12 through 14 illustrate processes that are performed at an NAT-PT server on performing security transmission using an IPsec transfer mode by AH in an IPv6 network having an NAT-PT function.

Referring to FIG. 12, when the NAT-PT server receives a packet to which an IPsec AH is applied (S610), the NAT-PT server determines the kind of packet (S620). For instance, preferably, the NAT-PT server checks a source address of the packet to determine the kind of packet.

As a result of the determination process (S610), if the received packet is an IPv6 packet, the NAT-PT server performs a process of translating the IPv6 packet (S630). If the received packet is an IPv4 packet, the NAT-PT server performs a process of translating the IPv4 packet (S640).

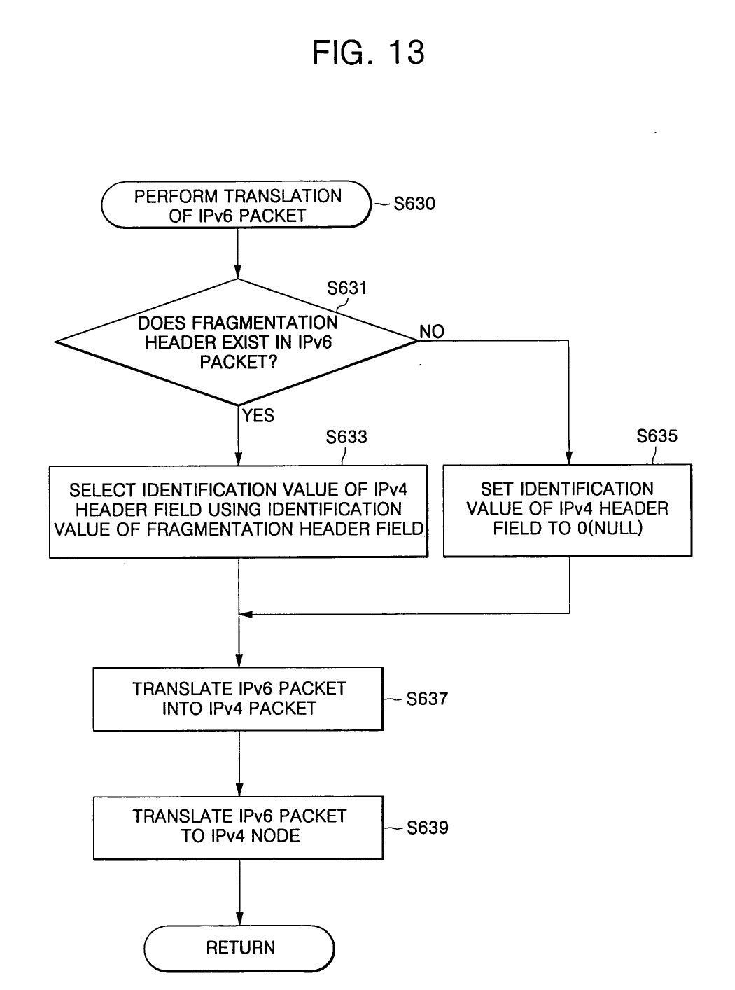

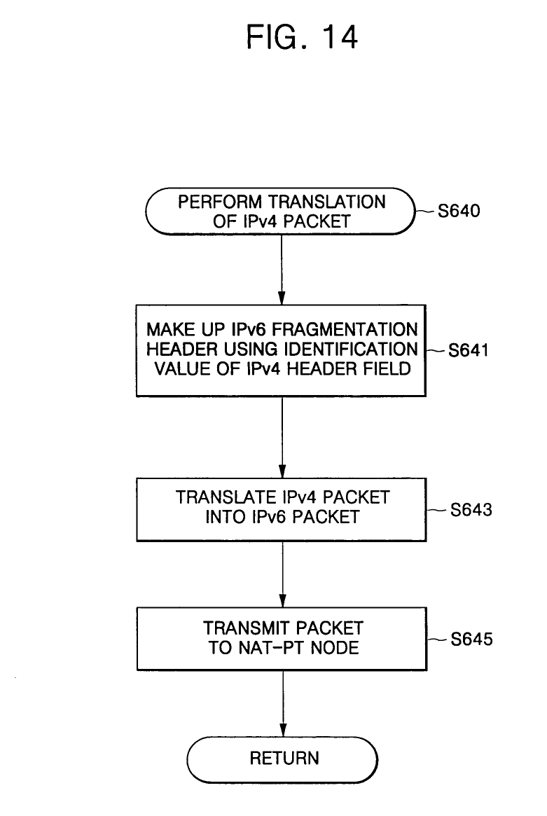

Details of the translation processes S630 and S640 are illustrated in FIGS. 13 and 14, respectively. Specifically, FIG. 13 illustrates an example of the process S630 of translating the IPv6 packet, and FIG. 14 illustrates an example of the process S640 of translating the IPv4 packet.

Hereinafter, the process S630 of translating the IPv6 packet will be described with reference to FIG. 13.

The NAT-PT server, receiving the IPv6 packet to which an IPsec AH is applied, determines whether a fragmentation header exists in the IPv6 packet (S631). As a result of the determinations process (S631), if the fragmentation header exists in the IPv6 packet, the NAT-PT server selects an identification value of an IPv4 header field using an identification value of the fragmentation header field (S633). However, if the fragmentation header does not exist in the IPv6 packet, the NAT-PT server sets the identification value of the IPv4 header field to ‘0(null)’ (S635).

The NAT-PT server then translates the IPv6 packet into the IPv4 packet on the basis of the previously stored address mapping table (S637), and transmits the IPv4 packet to the IPv4 node (S639). In the latter regard, the processes S637 and S639 are similar to those of S425 and S430 illustrated in FIG. 9.

The process of translating the IPv4 packet (S640) will now be described with reference to FIG. 14. The NAT-PT server, receiving the IPv4 packet to which an IPsec AH is applied, makes up an IPv6 fragmentation header using an identification value of the IPv4 header field (S641). If the identification value of the IPv4 header field is ‘0,’ the NAT-PT server considers that there is no IPv6 fragmentation header.

The NAT-PT server then translates the IPv4 packet into the IPv6 packet on the basis of the previously stored address mapping table (S643), and transmits the IPv6 packet to the NAT-PT node (S645). In the latter regard, the processes S643 and S645 are similar to those of S520 and S525 illustrated in FIG. 10.

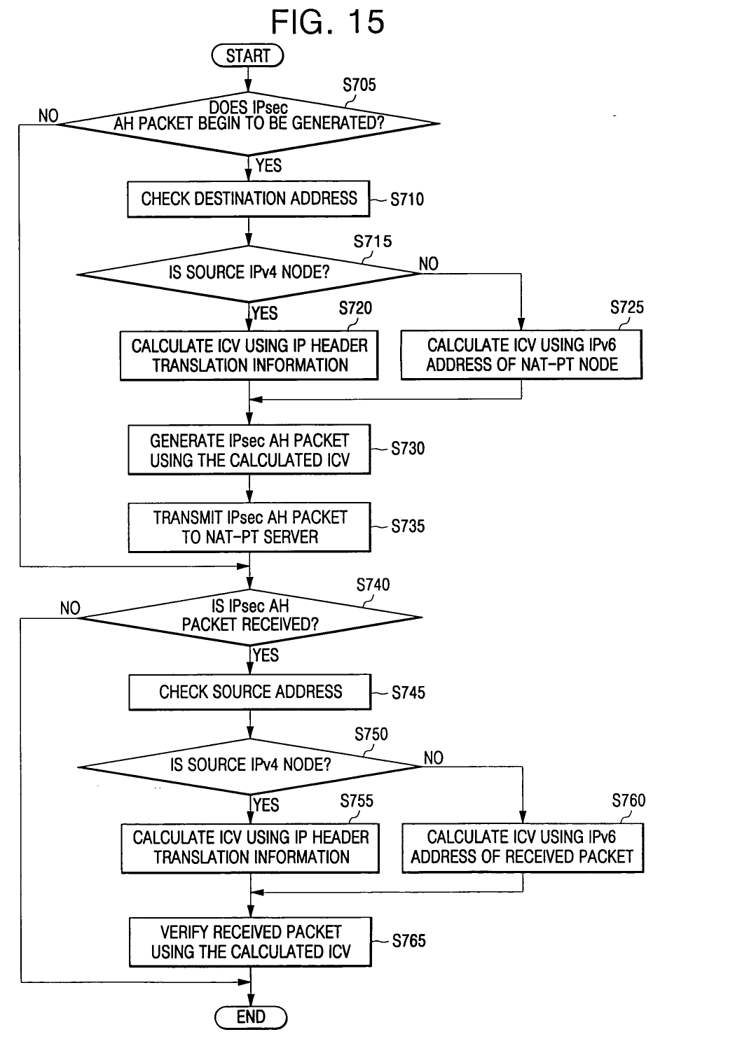

FIG. 15 illustrates a process that is performed at an NAT-PT node on performing an end-to-end security transmission process in accordance with one embodiment of the present invention. Particularly, FIG. 15 illustrates a process that is performed at an NAT-PT node on performing security transmission using an IPsec transfer mode by AH in an IPv6 network having an NAT-PT function.

Referring to FIG. 15, when the NAT-PT node intends to transmit a packet using the IPsec transfer mode by AH, the NAT-PT node calculates ICVs that are different from each other according to a destination to which the packet is to be transmitted, and generates the IPsec AHs using the ICVs.

To this end, when an IPsec AH packet begins to be generated (S705), the NAT-PT node checks a destination address to which the IPsec AH packet is to be transmitted (S710), thereby determining whether a destination of the IPsec AH packet is the IPv4 node (S715). As a result of the determination process (S715), if the destination of the IPsec AH packet is the IPv4 node, the NAT-PT node calculates the ICV using IP header translation information (i.e., an IPv4 address of the NAT-PT node) (S720). If not, the NAT-PT node calculates the ICV using an IPv6 address of the NAT-PT node (S725).

The NAT-PT node then generates the IPsec AH packet using the ICV calculated in the process S720 or S725 (S730), and transmits the IPsec AH packet to the NAT-PT server (S735). An example of the IPsec AH packet generated in the process S730 is as illustrated by reference number 41 of FIG. 9.

Further referring to FIG. 15, when the IPsec AH packet is received (S740), the NAT-PT node checks a source address of the IPsec AH packet (S745), thereby determining whether a source of the IPsec AH packet is the IPv4 node (S750). As a result of the determination process (S750), if the source of the IPsec AH packet is the IPv4 node, the NAT-PT node calculates the ICV using IP header translation information (i.e., an IPv4 address of the NAT-PT node) (S755). If not, the NAT-PT node calculates the ICV using an IPv6 address of the NAT-PT node (S760). Then, the NAT-PT node verifies the received IPsec AH packet using the ICV calculated in the process S755 or S760 (S765).

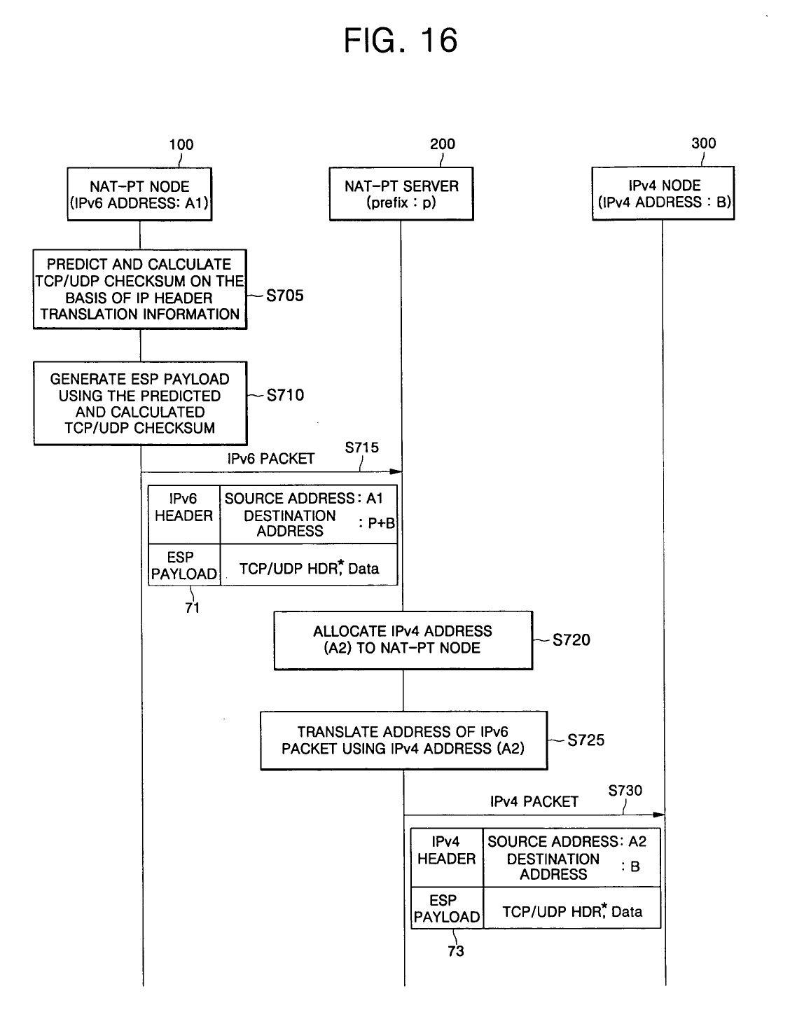

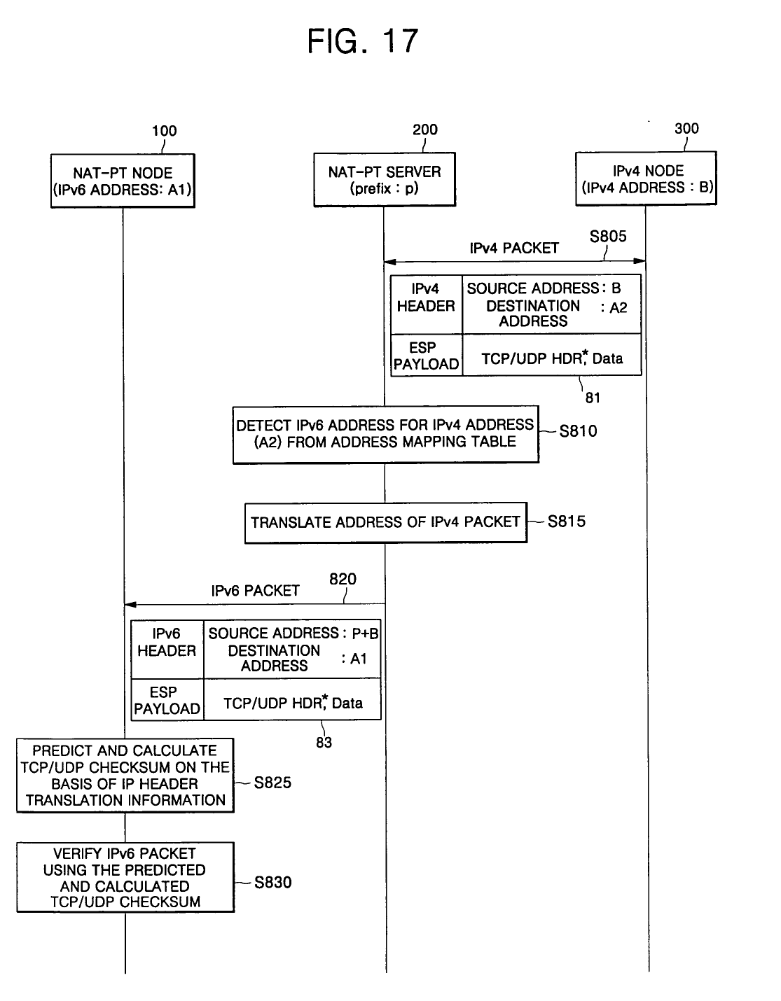

FIGS. 16 and 17 illustrate examples of an end-to-end security transmission process in accordance with another embodiment of the present invention. Particularly, FIGS. 16 and 17 illustrate processes of performing security transmission between an NAT-PT node 100 and an IPv4 node 300 using an IPsec transfer mode by AH in an IPv6 network having an NAT-PT function. In the latter regard, it is assumed that an IPv6 address of the NAT-PT node 100 is ‘A1,’ that a NAT-PT prefix is ‘P,’ and that an IPv4 address of the IPv4 node 300 is ‘B’. Therefore, FIG. 16 illustrates a process wherein the NAT-PT node 100 transmits packet data using the IPsec transfer mode by ESP, and FIG. 17 illustrates a process wherein the NAT-PT node 100 verifies the received packet data using the IPsec transfer mode by ESP.

In the case of the IPsec transfer mode by ESP, the NAT-PT node encrypts and transmits the packet data, together with a TCP/UDP (Transmission Control Protocol/User Datagram Protocol) checksum (including IPv6 address information of the NAT-PT node) that is included in the packet data. Thus, when the IPv4 node receiving the encrypted packet data through the NAT-PT server decrypts the packet data to check the TCP/UDP checksum, authentication ends in failure. In other words, because the IPv6 information of the NAT-PT node is included in the TCP/UDP checksum, and because the packet data which the IPv4 node receives includes source information subjected to address translation at the NAT-PT node, mismatch of the source address information causes the authentication to end in failure.

Thus, the present invention is configured so that, in the case of intending to perform security transmission by means of the IPsec transfer mode by ESP, the NAT-PT node predicts the TCP/UDP checksum using IP header translation information transmitted from the NAT-PT server in advance, and generates an IPsec ESP packet using the predicted result to perform authentication. This series of processes is illustrated in FIGS. 16 and 17.

Referring to FIG. 16, the NAT-PT node 100 predicts and calculates the TCP/UDP checksum on the basis of the IP header translation information that is stored in the previous processes (e.g., S110 of FIGS. 1 and 2 and S325 of FIG. 8) of performing security negotiation (S705), and generates an ESP payload using the predicted and calculated TCP/UDP checksum (S710). The NAT-PT node 100 generates an IPv6 packet including the ESP payload, and then transmits the IPv6 packet to the NAT-PT server 200 (S715). The IPv6 packet including the ESP payload refers to a packet transmitted by the use of the IPsec transfer mode by ESP, and an example is illustrated by reference number 71 in FIG. 16. Referring to the reference number 71, the IPv6 packet including the ESP payload is composed of an IPv6 header having a source IPv6 address A1, a destination IPv6 address P+B, and the ESP payload including encrypted TCP/UDP HDR* and data.

The NAT-PT server 200, receiving the IPv6 packet having the ESP payload, allocates an IPv4 address A2 to the NAT-PT node 100 on the basis of the previously stored address mapping table (S720). The NAT-PT server 200 translates an address of the IPv6 packet using the IPv4 address to generate an IPv4 packet (S725), and then transmits the IPv4 packet to the IPv4 node 300 (S730). For example, the NAT-PT server 200 translates the source IPv6 address A1 into the IPv4 address A2 allocated in the process S720, removes an NAT-PT prefix P from the destination IPv6 address P+B, and translates the IPv6 packet into the IPv4 packet. An example of the IPv4 packet transmitted in the process S730 is illustrated by reference number 73 in FIG. 16.

A process wherein the NAT-PT node 100 receives packet data using the IPsec transfer mode by ESP and verifies the packet data will now be described with reference to FIG. 17.

First, the IPv4 node 300 generates an IPv4 packet to which an IPsec ESP is applied, and transmits the IPv4 packet to the NAT-PT server 200 (S805). The IPv4 packet to which the IPsec ESP is applied is one which includes an ESP payload, similar to the IPv6 packet to which the IPsec ESP is applied, as described with reference to FIG. 16, which refers to one transmitted using the IPsec transfer mode by ESP, and an example of which is illustrated by reference number 81 in FIG. 17. Referring to reference number 81, the IPv4 packet to which the IPsec ESP is applied includes an IPv4 header having a source IPv4 address B, a destination IPv4 address A2, and an ESP payload including encrypted TCP/UDP HDR* and data.

The NAT-PT server 200 receiving the IPv4 packet to which the IPsec ESP is applied detects the IPv6 address, which is mapped to the destination IPv4 address A2 included in the IPv4 packet, from the previously stored address mapping table (S810). For example, according to what is illustrated in FIG. 4, when the IPv4 address is ‘A2,’ the NAT-PT server 200 detects the IPv6 address A1 because the IPv6 address A1 is mapped to the IPv4 address A2.

The NAT-PT server 200 translates an address of the IPv4 packet using the IPv6 address A1 to generate an IPv6 packet (S815), and transmits the IPv6 packet to the NAT-PT node 100 (S820). For example, the NAT-PT server 200 translates the source IPv4 address B into the IPv6 address P+B by adding an NAT-PT prefix P to the source IPv4 address B, and translates the destination IPv4 address A2 using the IPv6 address A1 detected in the process S810. An example of the IPv6 packet transmitted in the process S820 is illustrated by reference number 83 in FIG. 17.

The NAT-PT node 100 receiving the IPv6 packet calculates a TCP/UDP checksum on the basis of the previously stored IP header translation information in order to verify the received IPv6 packet (S825).

The NAT-PT node 100 then verifies the IPv6 packet received in the process S820 using the TCP/UDP checksum (S830). In other words, the NAT-PT node 100 verifies the IPv6 packet by comparing the calculated TCP/UDP checksum with the TCP/UDP checksum included in the IPv6 packet.

It should be understood that the present invention is directed to a method for providing security service using the address information in the communication network and using the disclosed address translation method. In the detailed description of the present invention, the method for providing the end-to-end security service using the IPsec in the IPv6 network having the NAT-PT function has been described by way of example. However, the present invention is not limited to the detailed description. Therefore, the scope of the present invention is not limited to the described embodiments, but is determined by the following claims and their equivalents.

As can be seen from the foregoing, the present invention transmits the address translation information to the ends in advance, thereby being capable of applying the security service using the address information on transmitting the data between the hosts in the communication network using the address translation method. For example, the present invention can apply the security service on transmitting the data between the ends using the IPsec in the IPv6 network having the NAT-PT function. Therefore, the present invention can transmit the data between the ends while maintaining security. In particular, the data are transmitted between the ends using the IPsec in the IPv6 network having the NAT-PT function, that it is possible to maintain security on transmitting the data.

Although exemplary embodiments of the present invention have been described, it should be understood that various changes and modification can be made within the spirit and scope of the present invention, as defined in the appended claims.

What is claimed is:

1. A method for providing end-to-end security service in a communication network having a network address translation-protocol translation function, the method comprising the steps of:
performing security negotiation between a first node included in a first communication network having the network address translation-protocol translation function and a second node included in a second communication network operating with a protocol different from the first communication network,
storing protocol translation information generated when the security negotiation is performed at the first node; and
performing security transmission between the first node and the second node using the stored protocol translation information.

2. The method of claim 1, further comprising the step of performing authentication between the first node and the second node using the stored protocol translation information.

3. The method of claim 2, wherein the step of performing the authentication comprises:
predicting, at the first node, address information to be translated on the basis of stored protocol translation information;
generating, at the first node, authentication information on the basis of the predicted address information;
transmitting the authentication information from the first node to the second node; and
authenticating, at the second node, the first node on the basis of the authentication information.

4. The method of claim 3, wherein the steps of performing the authentication further comprises:
generating, at the second node, authentication information on the basis of the address information of the second node;
transmitting the authentication information from the second node to the first node;
predicting, at the first node, translation address information of the first node on the basis of the stored protocol translation information; and
authenticating, at the first node, the second node using the predicted translation address information and the authentication information transmitted from the second node.

5. The method of claim 1, wherein the step of performing the security negotiation and storing the protocol translation information comprise:
translating, at a translation server for the network address and protocol translation, a protocol of a request message for the security negotiation to transmit the translated protocol to the second node in response to a request by the first node for the security negotiation;
transmitting, at the translation server, the protocol translation information to the first node in response to a response message from the second node;
storing, at the first node, the protocol translation information; and
translating, at the translation server, a protocol of the response message from the second node.

6. The method of claim 1, wherein the protocol translation information includes address information for the second communication network allocated to the first node so as to make it possible to recognize the first node in the second communication network.

7. The method of claim 1, wherein the first communication network is an IPv6 (Internet Protocol version 6) network and the second communication network is an IPv4 (Internet Protocol version 4) network.

8. The method of claim 7, wherein the protocol translation information is IP (Internet Protocol) header translation information between an IPv6 packet and an IPv4 packet.

9. The method of claim 1, wherein the security service makes use of IPsec (Internet Protocol Security).

10. The method of claim 1, wherein the step of performing the security transmission comprises transmitting and receiving packet data which includes an authentication header for permitting authentication of a data transmitter between the first node and the second node.

11. The method of claim 10, wherein the step of performing the security transmission further comprises:
calculating, at the first node, an integrity check value on the basis of the stored protocol translation information;
generating an authentication header including the integrity check value; and
generating packet data, including the authentication header, for transmission to the second node.

12. The method of claim 11, wherein the step of performing the security transmission further comprises;
receiving, at the first node, the packet data including the authentication header from the second node;
calculating, at the first node, the integrity check value on the basis of the stored protocol translation information and in response to the reception of the packet data; and
verifying the received packet data using the integrity check value.

13. The method of claim 1, wherein the step of performing the security transmission comprises transmitting and receiving packet data which includes an encapsulating security payload supporting authentication of a transmitter and data encryption between the first node and the second node.

14. The method of claim 13, wherein the step of performing the security transmission further comprises:
predicting and calculating, at the first node, a TCP/UDP (Transmission Control Protocol/User Datagram Protocol) checksum value on the basis of the stored protocol translation information;
generating, at the first node, the encapsulating security payload using the predicted and calculated TCP/UDP checksum value; and
transmitting the packet data, including the encapsulating security payload, to the second node.

15. The method of claim 13, wherein the step of performing the security transmission further comprises:
receiving, at the first node, the packet data which includes the encapsulating security payload from the second node;
predicting and calculating, at the first node, a TCP/UDP (Transmission Control Protocol/User Datagram Protocol) checksum value on the basis of the stored protocol translation information in response to the reception of the packet data; and
verifying the received packet data using the predicted and calculated TCP/UDP checksum value.

16. A method for providing end-to-end security service in an IPv6 (Internet Protocol version 6) network having a network address translation-protocol translation function, the method comprising the steps of:
performing security negotiation between an IPv6 node included in the IPv6 network and an IPv4 (Internet Protocol version 4) node included in an IPv4 network;
storing, in the IPv6 node, IP (Internet Protocol) header translation information, generated when the security negotiation is performed; and
performing security transmission between the IPv6 node and the IPv4 node using the stored IP header translation information.

17. The method of claim 16, further comprising the step of performing authentication between the IPv6 node and the IPv4 node using the stored IP header translation information.

18. The method of claim 17, wherein the step of performing the authentication comprises:
predicting, at the IPv6 node, address information to be translated on the basis of the stored IP header translation information;
generating, at the IPv6 node, authentication information on the basis of the predicted address information;
transmitting the authentication information to the IPv4 node; and
authenticating, at the IPv4 node, the IPv6 node on the basis of the authentication information.

19. The method of claim 18, wherein the step of performing the authentication further comprises:
generating, at the IPv4 node, authentication information on the basis of the address information of the IPv4 node;
transmitting the authentication information from the IPv4 node to the IPv6 node;
predicting, at the IPv6 node, translation address information of the IPv6 node on the basis of the stored IP header translation information; and
authenticating, at the IPv6 node, the IPv4 node using the predicted translation address information and the authentication information transmitted from the IPv4 node.

20. The method of claim 16, wherein the steps of performing the security negotiation and storing the IP header translation information comprise:
translating, at a translation server for the network address and protocol translation, an IP header of a request message for the security negotiation to transmit the translated IP header to the IPv4 node in response to a request by the IPv6 node for the security negotiation;
transmitting, at the translation server, the IP header translation information to the IPv6 node in response to a response message from the IPv4 node;
storing, at the IPv6 node, the IP header translation information; and
translating, at the translation server, an IP header of the response message for transmission to the IPv6 node.

21. The method of claim 16, wherein the IP header translation information includes an IPv4 address allocated to the IPv6 node so as to make it possible to recognize the IPv6 node in the IPv4 network.

22. The method of claim 16, wherein the security service makes use of IPsec (Internet Protocol Security).

23. The method of claim 16, wherein the step of performing the security transmission comprises transmitting and receiving packet data which includes an authentication header for permitting authentication of a data transmitter between the IPv6 node and the IPv4 node.

24. The method of claim 23, wherein the step of performing the security transmission further comprises:
calculating, at the IPv6 node, an integrity check value on the basis of the stored IP header translation information;
generating an authentication header including the integrity check value; and
generating packet data, including the authentication header, for transmission to the IPv4 node.

25. The method of claim 24, wherein the step of performing the security transmission further comprises;
receiving, at the IPv6 node, packet data including an authentication header from the IPv4 node;
calculating, at the IPv6 node, the integrity check value on the basis of the stored IP header translation information in response to the reception of the packet data; and
verifying the received packet data using the integrity check value.

26. The method of claim 16, wherein the step of performing the security transmission comprises transmitting and receiving packet data which includes an encapsulating security payload supporting authentication of a transmitter and data encryption between the IPv6 node and the IPv4 node.

27. The method of claim 26, wherein the step of performing the security transmission further comprises:
predicting and calculating, at the IPv6 node, a TCP/UDP (Transmission Control Protocol/User Datagram Protocol) checksum value on the basis of the stored IP header translation information;
generating, at the IPv6 node, the encapsulating security payload using the predicted and calculated TCP/UDP checksum value; and
transmitting the packet data, including the encapsulating security payload, to the IPv4 node.

28. The method of claim 26, wherein the step of performing the security transmission further comprises:
receiving, at the IPv6 node, the packet data which includes the encapsulating security payload from the IPv4 node;
predicting and calculating, at the IPv6 node, the TCP/UDP checksum value on the basis of the stored IP header translation information in response to the reception of the packet data; and
verifying the received packet data using the predicted and calculated TCP/UDP checksum value.
